(19) United States
(12) Patent Application Publication
(10) Pub. No.: US 2011/0003914 A1
(43) Pub. Date: Jan. 6, 2011

(54) RESIN COMPOSITION AND MULTILAYER RESIN FILM EMPLOYING THE SAME

(75) Inventors: Reona Yokota, Ibaraki (JP); Koichi Shibayama, Ibaraki (JP); Kazuyoshi Shiomi, Ibaraki (JP); Hiroshi Kouyanagi, Ibaraki (JP)

Correspondence Address: GREENBLUM & BERNSTEIN, P.L.C., 1950 ROLAND CLARKE PLACE, RESTON, VA, 20191, US

(73) Assignee: SEKISUI CHEMICAL CO., LTD., Osaka (JP)

(21) Appl. No.: 12/676,943

(22) PCT Filed: Jan. 30, 2009
(86) PCT No.: PCT/JP2009/051540

§ 371 Date: Jun. 24, 2010

(30) Foreign Application Priority Data
Jan. 31, 2008 (JP) 2008-020781
Mar. 19, 2008 (JP) 2008-071097

(51) Int. Cl. C08K 5/07; C08K 5/101

(52) U.S. Cl. 523/454; 523/455

(57) ABSTRACT

A resin composition is provided which allows improvement of the ultraviolet laser processability of the resin and can be not only used as an electronic material for an insulating film of a build-up board and the like but also used to form a circuit board whose electrical insulating property does not deteriorate. A multilayer resin film employing the resin composition is provided. A resin composition is provided which contains a thermosetting resin (A), a curing agent (B), a silica (C), an ultraviolet absorber (D), and a solvent (E) and in which: the content of the ultraviolet absorber (D) is from 0.5 to 50 parts by weight per the total amount of the thermosetting resin (A), the curing agent (B), and the ultraviolet absorber (D); and the blending amount of the solvent (E) is from 20 to 500 parts by weight per 100 parts by weight of the total amount of the thermosetting resin (A) and the curing agent (B). A multilayer resin film is provided in which the resin composition is laminated on a base material so as to be in a sheet shape and in which: the sheet-shaped resin composition on the base material is dried; and the content of the solvent is from 0.01 to 5 parts by weight with respect to the entire resin composition.

### TECHNICAL FIELD

The present invention relates to a resin composition and a multilayer resin film employing the resin composition, and more specifically, to: a resin composition which allows improvement of the ultraviolet laser processability of the resin and can be not only used as an electronic material for an insulating film of a build-up board and the like but also used to form a circuit board whose electrical insulating property does not deteriorate; and a multilayer resin film employing the resin composition.

### BACKGROUND ART

In accordance with enhancement of functions of electronic apparatuses, the density of integration of electronic parts has been increased, and further the density of mounting of electronic parts has been increased. In these electronic parts, epoxy resins and polyimide resins have been used as insulating materials for a multilayer wiring board and the like. Recently, in accordance with a further increase in the speeds and a further reduction in the sizes of electronic apparatuses, there is a demand for excellent close contact with a conductor and excellent chemical resistance. In order to meet the demand, there is a proposal for an epoxy resin composition that contains: a polysilane compound having a hydroxyl group; and an epoxy compound (e.g., see Patent Document 1).

In addition, in manufacturing a multilayer wiring board, drilling using a laser has been used recently. However, an epoxy resin composition has a narrow absorption band of wavelength for a laser and hence requires a large number of shots for processing, which requires high energy. In particular, an ultraviolet laser enables fine processing of resin as compared to a carbon dioxide gas laser, but the ultraviolet laser has a problem that, as compared to the carbon dioxide gas laser, the number of shots of the laser is increased and a lot of energy is required during processing of resin. Thus, damage to the resin is likely to be great, a crack may occur in an insulating layer, a copper foil land in an inner layer may be hollowed, and a crack may occur below the land. There is a method of optimizing laser conditions for solving these problems, but the method has a problem that it has a narrow allowable range.

In such a situation, there is a proposal for forming an insulating layer of a multilayer wiring board by using a resin composition that is obtained by blending an ultraviolet absorber in a thermoplastic resin and/or a thermosetting resin (e.g., see Patent Document 2). For example, because an ultraviolet absorber is added in an amount of 0.1 to 0.5% by weight to a thermosetting resin and/or a thermoplastic resin that have a narrow ultraviolet absorption band, the resin composition can be laser-processed at a reduced number of shots after being cured, thereby eliminating occurrence of a crack.

However, when the insulating layer obtained from this resin composition is dried and cured at a temperature of 200 to 250° C., the ultraviolet absorber contained in the resin composition decomposes and becomes inactive so as to lose its function. This becomes a cause for occurrence of a crack or shape defect of a via, which may result in insufficient electrical insulation.

Patent Document 1: Japanese Laid-Open Patent Publication No. 2000-265064

Patent Document 2: Japanese Laid-Open Patent Publication No. 2002-121360

### DISCLOSURE OF THE INVENTION

### Problems to be Solved by the Invention

The present invention has been made in view of the above problems of the conventional art, and its object is to provide a resin composition which allows improvement of the ultraviolet laser processability of the resin and can be not only used as an electronic material for an insulating film of a build-up board and the like but also used to form a circuit board whose electrical insulating property does not deteriorate; and a multilayer resin film employing the resin composition.

### Solution to the Problems

The inventors of the present invention have found, as a result of thorough research for achieving the above object, that a resin composition that is obtained by: blending a specific amount of a cyanoacrylate compound or a benzophenone compound as an ultraviolet absorber together with a curing agent and a silica in a thermosetting resin such as an epoxy resin; and kneading the mixture with a specific amount of a solvent, has an improved laser processability when grooves are formed by using an ultraviolet laser after the resin composition is cured, and thus the inventors have completed the present invention.

Specifically, a first aspect of the present invention provides a resin composition comprising a thermosetting resin (A), a curing agent (B), a silica (C), an ultraviolet absorber (D), and a solvent (E), wherein the ultraviolet absorber (D) is a cyanoacrylate compound (D1) and/or a benzophenone compound (D2), the content of the ultraviolet absorber (D) is from 0.5 to 50 parts by weight per the total amount of the thermosetting resin (A), the curing agent (B), and the ultraviolet absorber (D), and the blending amount of the solvent (E) is from 20 to 500 parts by weight per 100 parts by weight of the total amount of the thermosetting resin (A) and the curing agent (B).

Further, a second aspect of the present invention based on the first aspect provides a resin composition wherein the content of the ultraviolet absorber (D) is from 1.0 to 30 parts by weight per the total amount of the thermosetting resin (A), the curing agent (B), and the ultraviolet absorber (D).

Further, a third aspect of the present invention based on the first or second aspect provides a resin composition wherein the cyanoacrylate compound (D1) or the benzophenone compound (D2) has an absorption maximum in a wavelength range of 200 to 380 nm.

Further, a fourth aspect of the present invention based on any one of the first to third aspects provides a resin composition wherein the cyanoacrylate compound (D1) is a compound that has an alkyl group with 1 to 10 carbons, a cycloalkyl group, an aryl group, an aryl-alkyl group, and/or two or more aryl-acryloxy groups.

Further, a fifth aspect of the present invention based on the fourth aspect provides a resin composition wherein the cyanoacrylate compound (D1) is a compound that has an alkyl group with 2 to 8 carbons and two aryl groups, or a compound that has two or more aryl-acryloxy groups.

Further, a sixth aspect of the present invention based on any one of the first to fifth aspects provides a resin composition wherein the benzophenone compound (D2) is benzophenone; a compound that has one of a hydroxyl group, a hydroxy-alkyl group, an alkyloxy group, an aryloxy group, an aryl-alkyloxy group, and a carboxyl group; or an acid anhydride thereof.

Further, a seventh aspect of the present invention based on the sixth aspect provides a resin composition wherein the benzophenone compound (D2) is a compound that has one of a hydroxyl group and a hydroxy-alkyl group, or an acid anhydride thereof.

Further, an eighth aspect of the present invention based on any one of the first to seventh aspects provides a resin composition wherein the weight ratio of the thermosetting resin (A) to the curing agent (B) is from 30:70 to 70:30.

Further, a ninth aspect of the present invention based on any one of the first to eighth aspects provides a resin composition wherein the thermosetting resin (A) is an epoxy resin.

Further, a tenth aspect of the present invention based on any one of the first to ninth aspects provides a resin composition wherein the curing agent (B) includes at least one or more compounds selected from dicyandiamide, a phenolic curing agent, and an acid anhydride.

Further, an eleventh aspect of the present invention based on any one of the first to tenth aspects provides a resin composition wherein the blending amount of the silica (C) is from 10 to 100 parts by weight per 100 parts by weight of the total amount of the thermosetting resin (A) and the curing agent (B).

Further, a twelfth aspect of the present invention based on the eleventh aspect provides a resin composition wherein the silica (C) is surface-treated with a silane coupling agent.

Moreover, a thirteenth aspect of the present invention based on any one of the first to twelfth aspects provides a resin composition further comprising a layer silicate, wherein the content of the layer silicate is from 0.1 to 25 parts by weight per 100 parts by weight of the total amount of the thermosetting resin (A) and the curing agent (B).

Further, a fourteenth aspect of the present invention based on the thirteenth aspect provides a resin composition wherein the layer silicate is a smectite clay mineral and/or a swelling mica.

On the other hand, a fifteenth aspect of the present invention provides a multilayer resin film in which the resin composition according to any one of the first to fourteenth aspects is laminated on a base material, wherein the resin composition is formed in a sheet shape, the sheet-shaped resin composition is dried, and the content of the solvent in the sheet-shaped resin composition is from 0.01 to parts by weight with respect to the entire resin composition.

Further, a sixteenth aspect of the present invention based on the fifteenth aspect provides a multilayer resin film wherein the multilayer resin film is used as an insulating material of a circuit board and has an excellent processability for ultraviolet laser processing.

### EFFECT OF THE INVENTION

The resin composition of the present invention contains a specific amount of a specific ultraviolet absorber, and each ingredient thereof is uniformly dispersed by a specific amount of a solvent. Thus, the absorption of light near the wavelength of ultraviolet light increases, and hence the laser processability of the resin improves.

In addition, when the resin composition or the resin film is used as an electronic material for an insulating film of a build-up board and the like, the effect that the electrical insulating property does not deteriorate is provided.

### BEST MODE FOR CARRYING OUT THE INVENTION

The following will describe in detail a resin composition of the present invention and a multilayer resin film employing the resin composition.

1. Resin Composition

The resin composition of the present invention contains a thermosetting resin (A), a curing agent (B), a silica (C), an ultraviolet absorber (D), and a solvent (E). The ultraviolet absorber (D) is a cyanoacrylate compound (D1) and/or a benzophenone compound (D2), and its content is from 0.5 to 50 parts by weight per the total amount of the thermosetting resin (A), the curing agent (B), and the ultraviolet absorber (D). The blending amount of the solvent (E) is from 20 to 500 parts by weight per 100 parts by weight of the total amount of the thermosetting resin (A) and the curing agent (B).

(1) Thermosetting Resin (A)

In the present invention, the thermosetting resin is not particularly limited, and examples thereof include amino resins such as epoxy resins, phenoxy resins, phenolic resins, urea resins, and melamine resins; unsaturated polyester resins; thermosetting urethane resins; thermosetting polyimide resins; benzoxazine resins; and amino alkyd resins. These thermosetting resins may be used solely, or two or more types thereof may be used in combination.

Among these thermosetting resins, an epoxy resin having two or more epoxy groups (oxirane rings) per molecule is preferred.

Known epoxy resins that are conventionally used in this field can be used as the epoxy resins, and examples thereof include various epoxy compounds such as aromatic epoxy resins, alicyclic epoxy resins, aliphatic epoxy resins, glycidyl ester epoxy resins, glycidyl amine epoxy resins, glycidyl acrylic epoxy resins, and polyester epoxy resins, which will be described below. These epoxy resins may be used solely, or two or more types thereof may be used in combination.

Examples of the aromatic epoxy resins include biphenyl phenolic epoxy resins, bisphenol epoxy resins, and novolac epoxy resins. Examples of the bisphenol epoxy resins include bisphenol A epoxy resins, bisphenol F epoxy resins, bisphenol AD epoxy resins, and bisphenol S epoxy resins. Examples of the novolac epoxy resins include phenol novolac epoxy resins, and cresol novolac epoxy resins. In addition, examples of the novolac epoxy resins also include epoxy resins formed from an aromatic compound such as trisphenol methane triglycidyl ether and the like.

Examples of the alicyclic epoxy resins include 3,4-epoxycyclohexyl methyl-3,4-epoxycyclohexane carboxylate, 3,4-epoxy-2-methylcyclohexylmethyl-3,4-epoxy-2-methylcyclohexane carboxylate, bis(3,4-epoxycyclohexyl)adipate, bis(3,4-epoxycyclohexylmethyl)adipate, bis(3,4-epoxy-6-methylcyclohexylmethyl)adipate, 2-(3,4-epoxycyclohexyl-5,5-spiro-3,4-epoxy)cyclohexanone-metha-dioxane, and bis(2,3-epoxycyclopentyl)ether. Examples of marketed products of such epoxy resins include trade name “EHPE-3150” (softening temperature: 71° C.), available from Daicel Chemical Industries, Ltd.

Examples of the aliphatic epoxy resins include a diglycidyl ether of neopentyl glycol, a diglycidyl ether of 1,4-butanediol, a diglycidyl ether of 1,6-hexanediol, a triglycidyl ether of glycerin, a triglycidyl ether of trimethylolpropane, a diglycidyl ether of polyethylene glycol, a diglycidyl ether of polypropylene glycol, and poly glycidyl ethers of long-chain polyols including: polyoxy alkylene glycols having an alkylene group with 2 to 9 (preferably 2 to 4) carbons; polytetramethylene ether glycols; and the like.

Examples of the glycidyl ester epoxy resins include phthalic acid diglycidyl ester, tetrahydrophthalic acid diglycidyl ester, hexahydrophthalic acid diglycidyl ester, diglycidyl-p-oxybenzoate, a glycidyl ether-glycidyl ester of salicylic acid, and dimer acid glycidyl ester.

Examples of the glycidyl amine epoxy resins include triglycidyl isocyanurates, N,N′-diglycidyl derivatives of cyclic alkylene ureas, the N,N,O-triglycidyl derivative of p-aminophenol, and the N,N,O-triglycidyl derivative of m-aminophenol.

Examples of the glycidyl acrylic epoxy resins include copolymers of glycidyl (meth)acrylate, and radical polymerizable monomers such as ethylene, vinyl acetate, and (meth) acrylic acid ester.

Examples of the polyester epoxy resins include polyester resins having one or more epoxy groups, preferably, two or more epoxy groups per molecule.

In addition, examples of the epoxy resins also include compounds that are obtained by epoxidation of double bonds of unsaturated carbons in: polymers having, as a principal component, conjugated diene compounds such as epoxidized polybutadienes; or polymers that are partially hydrogenated products thereof.

Examples of the epoxy resins also include compounds that are obtained by epoxidation of double bonds of unsaturated carbons of conjugated diene compounds in block copolymers having within the same molecule: a polymer block with a vinyl aromatic compound as a principal component; and a polymer block having a conjugated diene compound as a principal component or a polymer block that is a partially hydrogenated product thereof. Examples of such compounds include epoxidized SBS.

Further, derivatives or hydrogenated products of these epoxy resins may be used, and examples thereof include urethane-modified epoxy resins and polycaprolactone-modified epoxy resins that are obtained by introduction of urethane bonds or polycaprolactone bonds into the structure of any of the above epoxy resins.

It is preferred if the thermosetting resin contains an epoxy resin that is in the form of a liquid at ordinary temperature, because the thermosetting resin has an excellent close contact with a circuit board.

It is preferred if the thermosetting resin contains an epoxy resin that is in the form of a liquid at ordinary temperature in an amount of 25 parts by weight or more per 100 parts by weight of the thermosetting resin, because the ultraviolet laser processability of the thermosetting resin further improves.

Examples of the epoxy resin that is in the form of a liquid at ordinary temperature include bisphenol A epoxy resins, bisphenol F epoxy resins, and glycidyl ester epoxy resins.

(2) Curing Agent (B)

In the present invention, the curing agent is not particularly limited as long as it has a function to cure the thermosetting resin, and conventionally known curing agents can be used. Examples of curing agents for epoxy resins include amine compounds, compounds synthesized from amine compounds, imidazole compounds, hydrazide compounds, melamine compounds, acid anhydrides, phenolic compounds (phenolic curing agents), ester compounds, heat-latent cationic polymerization catalysts, optical-latent cationic polymerization initiators, dicyandiamide, and derivatives thereof.

Among these curing agents, dicyandiamide, phenolic curing agents, or acid anhydrides are preferred. These curing agents may be used solely, or two or more types thereof may be used in combination.

Examples of the amine compounds include chain aliphatic amine compounds, cyclic aliphatic amines, and aromatic amines. Examples of the chain aliphatic amine compounds include ethylenediamine, diethylenetriamine, triethylenetetramine, tetraethylenepentamine, polyoxypropylenediamine, and polyoxypropylenetriamine. Examples of the cyclic aliphatic amines include menthenediamine, isophoronediamine, bis(4-amino-3-methylcyclohexyl)methane, diaminodicyclohexylmethane, bis(aminomethyl)cyclohexane, N-aminoethylpiperazine, and 3,9-bis(3-aminopropyl)-2,4,8,10-tetraoxaspiro(5,5)undecane.

Examples of the aromatic amine compounds include m-xylenediamine, α-(m/p-aminophenyl)ethylamine, m-phenylenediamine, diaminodiphenylmethane, diaminodiphenyl sulfone, and α,α-bis(4-aminophenyl)-p-diisopropylbenzene.

Examples of the compounds synthesized from amine compounds include polyaminoamide compounds, polyaminoimide compounds, and ketimine compounds. Examples of the polyaminoimide compounds include compounds synthesized from the above amine compounds and carboxylic acids. Examples of the carboxylic acids include succinic acid, adipic acid, azelaic acid, sebacic acid, dodecanedioic acid, isophthalic acid, terephthalic acid, dihydroisophthalic acid, tetrahydroisophthalic acid, and hexahydroisophthalic acid. Examples of the polyaminoimide compounds include compounds synthesized from the above amine compounds and maleimide compounds. Examples of the maleimide compounds include diaminodiphenylmethane bismaleimide. Examples of the ketimine compounds include compounds synthesized from the above amine compounds and ketone compounds.

In addition, examples of the compounds synthesized from amine compounds also include compounds synthesized from: the above amine compounds; and compounds such as epoxy compounds, urea compounds, thiourea compounds, aldehyde compounds, phenolic compounds, and acrylic compounds.

Examples of tertiary amine compounds include N,N-dimethylpiperazine, pyridine, picoline, benzyldimethylamine, 2-(dimethylaminomethyl)phenol, 2,4,6-tris(dimethylaminomethyl)phenol, and 1,8-diazabiscyclo(5,4,0)undecene-1.

Examples of the imidazole compounds include 2-2-methylimidazole, 2-undecylimidazole, 2-heptadecylimidazole, and 2-phenylimidazole.

Examples of the hydrazide compounds include 1,3-bis(hydrazinocarboethyl)-5-isopropylhydantoin, 7,11-octadecadiene-1,18-dicarbohydrazide, icosanedioic acid dihydrazide, and adipic acid dihydrazide.

Examples of the melamine compounds include 2,4-diamino-6-vinyl-1,3,5-triazine.

Examples of the acid anhydrides include phthalic anhydride, trimellitic anhydride, pyromellitic anhydride, benzophenone tetracarboxylic anhydride, ethylene glycol bis(anhydrotrimellitate), glycerol tris(anhydrotrimellitate), methyltetrahydrophthalic anhydride, tetrahydrophthalic anhydride, nadic anhydride, methyl nadic anhydride, trialkyltetrahydrophthalic anhydride, hexahydrophthalic anhydride, methylhexahydrophthalic anhydride, 5-(2,5-dioxotetrahydrofuril)-3-methyl-3-cyclohexene-1,2-dicarboxylic anhydride, trialkyltetrahydrophthalic anhydride-maleic anhydride adducts, dodecenyl succinic anhydride, polyazelaic anhydride, polydodecanedioic anhydride, and chlorendic anhydride.

Examples of the phenolic compounds include phenolic novolac, o-cresol novolac, p-cresol novolac, t-butyl phenolic novolac, dicyclopentadiene cresol, and derivatives thereof. As derivatives of phenolic novolac, an aminotriazine novolac (ATN) resin represented by the following Formula (1) and a terpene-modified resin represented by the following Formula (2) can be used. It is noted that the number n of repeat units in Formula (1) is from 1 to 10 and the number m of repeat units in Formula (2) is from 1 to 10. One example of a derivative of cresol novolac is a cresol aminotriazine novolac (CATN) resin. These phenolic compounds may be used solely, or two or more types thereof may be used in combination.

The phenolic curing agents can improve heat resistance, a low water-absorbing property, and dimensional stability. For that reason, when benzophenone tetracarboxylic dianhydride is selected as a phenolic curing agent, the blending amount of the ultraviolet absorber can be reduced considerably, and the ultraviolet absorber may not be blended when another condition is optimized.

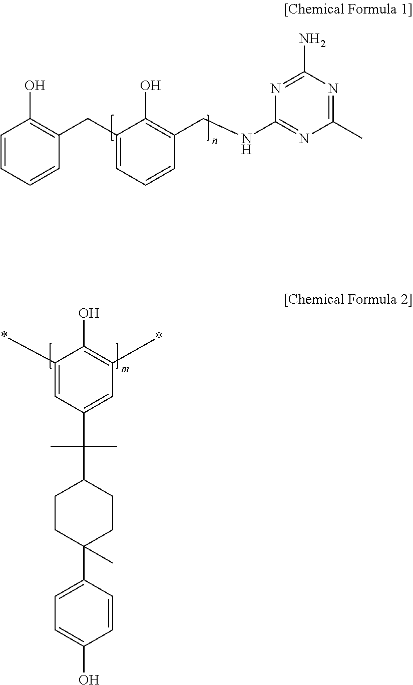

In the resin composition of the present invention, a curing accelerator may be used together with the curing agent for the epoxy resin, in order to adjust a curing speed and the properties of a cured product. The curing accelerator is not particularly limited, and examples thereof include imidazole curing accelerators and tertiary amine curing accelerators. Among these curing accelerators, imidazole curing accelerators are suitably used, because it is easy to control a reaction system for adjusting the curing speed and the properties of the cured product. These curing accelerators may be used solely, or two or more types thereof may be used in combination.

Examples of the imidazole curing accelerators include 1-cyanoethyl-2-phenylimidazole in which the 1-position of the imidazole is protected by a cyanoethyl group, and trade name “2MA-OK” (available from SHIKOKU CHEMICALS CORPORATION) in which the basicity is protected by isocyanuric acid. These imidazole curing accelerators may be used solely, or two or more types thereof may be used in combination.

In the resin composition of the present invention, the weight ratio of the thermosetting resin to the curing agent is 30 to 70:70 to 30. The weight ratio of the thermosetting resin to the curing agent is preferably 40 to 70:60 to 30 and more preferably 50 to 70:50 to 30. When the curing agent is 30 or more in the weight ratio relative to the epoxy resin, it is less likely to insufficiently cure the epoxy resin. When the curing agent is 70 or less in the weight ratio relative to the epoxy resin, it is less likely to decrease the strength properties and the adhesive strength reliability of the cured product of the epoxy resin due to excess of the curing agent.

In the resin composition of the present invention, the equivalent ratio of the thermosetting resin to the curing agent is preferably 1:0.7 to 1.5.

(3) Silica (C)

In the present invention, the silica is blended as an inorganic filler. In addition to the silica, examples of inorganic fillers include layer silicate, alumina, silicon nitride, hydrotalcite, and kaolin.

Among the silica, a spherical silica having an average particle diameter of 2 to 15 μm is suitable. When the average particle diameter is 2 μm or more, the silica can be highly packed. When the average particle diameter is 15 μm or less, projections and depressions are less likely to occur on a surface, and high evenness is obtained.

The silica is not particularly limited, but a silica that is treated with a silane coupling agent (adhesion imparter) is preferred. Examples of the silane coupling agent include epoxy silane coupling agents, amino silane coupling agents, ketimine silane coupling agents, imidazole silane coupling agents, and cationic silane coupling agents.

When such a silane coupling agent is used, affinity with the silica becomes excellent. Thus, the silica that is treated with the silane coupling agent excels in a reinforcing effect of a resin.

In the resin composition of the present invention, the blending amount of the silica is from 10 to 100 parts by weight per 100 parts by weight of the total amount of the thermosetting resin and the curing agent. In particular, the silica is preferably blended in an amount of 50 to 85 parts by weight. When the blending amount of the silica is 10 parts by weight or more, a sufficient effect of decreasing linear expansion due to the silica is obtained, and a desired heat resistance such as thermal cycling resistance and high-temperature standing resistance is also obtained. On the other hand, when the blending amount of the silica is 100 parts by weight or less, a sufficient adhesive strength to and a sufficient close contact with a circuit board in which resin-cured products are laminated are obtained.

Further, in the resin composition of the present invention, the blending amount of the silica is from 10 to 120 parts by weight and preferably from 25 to 120 parts by weight, per 100 parts by weight of the total amount of all ingredients other than the solvent in the thermosetting resin composition. In particular, the silica is preferably blended in an amount of 35 to 100 parts by weight. When the blending amount of the silica is 25 parts by weight or more, a sufficient effect of decreasing linear expansion due to the silica is obtained, and a desired heat resistance such as thermal cycling resistance and high-temperature standing resistance is also obtained. On the other hand, when the blending amount of the silica is 120 parts by weight or less, a sufficient adhesive strength and a sufficient close contact with a circuit board in which resin-cured products are laminated are obtained.

The layer silicate that can be used as the inorganic filler is a silicate mineral that has exchangeable metal cation between layers thereof, and examples thereof include montmorillonite, swelling mica, and hectorite. These layer silicates decrease a linear expansion coefficient by being added in a small amount, thereby improving heat resistance, such as thermal cycling resistance and high-temperature standing resistance, as compared to the silica. Thus, a decrease of the bonding strength to a board in which resin-cured products are laminated can be prevented.

When such a layer silicate is used, the layer silicate is preferably blended in an amount of 0.1 to 25 parts by weight per 100 parts by weight of the total amount of the thermosetting resin (A) and the curing agent (B). A more preferable range of the layer silicate is from 0.5 to 10 parts by weight.

When the blending amount of the layer silicate is 0.1 parts by weight or more, the effect of decreasing linear expansion and the effect of improving heat resistance such as thermal cycling resistance and high-temperature standing resistance due to the layer silicate become marked. On the other hand, when the blending amount of the layer silicate is 25 parts by weight or less, desired formability into a shape such as a film shape and the like can be assured due to the viscosity of the resin composition.

(4) Ultraviolet Absorber (D)

In the present invention, the ultraviolet absorber is the cyanoacrylate compound (D1) or the benzophenone compound (D2), and a compound that has an absorption band corresponding to the wavelength of an ultraviolet laser to be used can be selected as appropriate. For example, a compound that has absorption in the ultraviolet wavelength range of 200 to 380 nm and in particular has an absorption maximum in the ultraviolet wavelength range of 300 to 320 nm, is preferred.

The cyanoacrylate compound or the benzophenone compound can improve the processability of an epoxy resin cured product with an ultraviolet laser, because it has an absorption maximum at or near 300 nm. A cyanoacrylate and a benzophenone that have excellent solubility to the solvent are preferred. However, a cyanoacrylate and a benzophenone that contain chlorine in such an amount that an electrical insulating property may deteriorate are excluded.

(4-1) Cyanoacrylate Compound (D1)

In the present invention, the cyanoacrylate compound is a compound that has an alkyl group with 1 to 10 carbons, a cycloalkyl group, an aryl group, an aryl-alkyl group, and/or two or more aryl-acryloxy groups, and is preferably a compound that has an alkyl group with 2 to 8 carbons and two aryl groups or a compound that has two or more aryl-acryloxy groups. The number of substituents is, for example, from 1 to 5. Specific examples of the cyanoacrylate compound include ethyl-2-cyano-3,3-diphenylacrylate, 2-ethylhexyl-2-cyano-3,3-diphenylacrylate, and 1,3-bis-[2′-cyano-(3′,3-diphenylacryloyl)oxy]-2,2-bis-{[2′-cyano-(3′,3-diphenylacryloyl)oxy]methyl}propane.

(4-2) Benzophenone Compound (D2)

In the present invention, examples of the benzophenone compound include benzophenone; a compound that has one of a hydroxyl group, a hydroxy-alkyl group, an alkyloxy group, an aryloxy group, an aryl-alkyloxy group, and a carboxyl group; and acid anhydrides thereof. A compound that has a hydroxyl group or a hydroxy-alkyl group, or an acid anhydride thereof is preferred. The number of functional groups such as a hydroxyl group is, for example, from 1 to 5, and preferably from 2 to 4.

Specific examples of the benzophenone compound include benzophenone, 2-hydroxy-4-methoxybenzophenone, 2,2-dihydroxy-4,4-dimethoxybenzophenone, 2,2′,4,4′-tetrahydroxybenzophenone, 2,2′-dihydroxy-4,4′-dimethoxybenzophenone, and 3,3′,4,4′-benzophenon tetracarboxylic dianhydride.

The ultraviolet absorbers can be used solely, or two or more types thereof may be used in combination. The content of the ultraviolet absorber is preferably from 0.5 to 50 parts by weight per the total amount of the thermosetting resin and the curing agent. The content of the ultraviolet absorber is more preferably from 1.0 to 30 parts by weight and even more preferably from 2.5 to 10 parts by weight. When the content is less than 0.5 parts by weight, the effect on processability is small. When the content exceeds 2.5 parts by weight, a marked effect on processability appears. On the other hand, when the content is 50 parts by weight or less, mechanical properties and electronic properties due to the thermoplastic resin and the curing agent are not decreased considerably.

The above Patent Document 2 discloses an inter-layer insulating resin composition for a multilayer printed wiring board, which is obtained by blending a thermosetting resin with an ultraviolet absorber such as hydroxyphenylbenzotriazole. Patent Document 2 describes “the energy absorption efficiency is increased and the energy of an applied laser is reduced during ultraviolet laser processing, thereby improving the processability and reducing cracks around BVH”. However, even when such hydroxyphenylbenzotriazole is used, the productivity (processability) cannot be improved in a technology of forming grooves in a surface of an insulating material by using a laser.

(5) Solvent (E)

In the resin composition of the present invention, the solvent is used for dissolving or dispersing the resin, the silica, the ultraviolet absorber, etc.

Examples of the solvent include hydrocarbon solvents such as hexane, heptane, octane, toluene, and xylene; alcohol solvents such as methanol, ethanol, isopropanol, butanol, aminoalcohols, 2-ethylhexyl alcohol, and cyclohexanol; ether solvents such as hexyl ether, dioxane, ethylene glycol monomethyl ether, ethylene glycol monoethyl ether, ethylene glycol monobutyl ether, ethylene glycol diethyl ether, and diethylene glycol monobutyl ether; ketone solvents such as methyl ethyl ketone, methyl isobutyl ketone, cyclohexanone, and isophorone; ester solvents such as ethyl acetate, butyl acetate, amyl acetate, ethylene glycol monomethyl ether acetate, and diethylene glycol monoethyl ether acetate; and aromatic petroleum derivatives such as Solvesso #100 and Solvesso #150 (both are trademarks, available from Shell Chemicals).

Among these solvents, hexane, toluene, and methyl ethyl ketone are preferred.

In the resin composition, the blending amount of the solvent is from 20 to 500 parts by weight, preferably from 50 to 300 parts by weight, and more preferably from 100 to 200 parts by weight, per 100 parts by weight of the total amount of the thermosetting resin and the curing agent. When the blending amount is 20 parts by weight or more, the resin, the silica, the ultraviolet absorber, the layer silicate, etc. can be sufficiently dissolved or dispersed. On the other hand, when the blending amount is 500 parts by weight or less, energy required for volatilizing the solvent is low, and temperature variation due to volatilization of the solvent is less likely to occur when the resin composition is cured.

(6) Other Additives (F)

In the resin composition of the present invention, a thermoplastic resin may be blended according to need. The thermoplastic resin is not particularly limited, and examples thereof include vinyl acetate resins, ethylene-vinyl acetate copolymers, acrylic resins, polyvinyl acetal resins such as polyvinyl butyral resins, styrene resins, saturated polyester resins, thermoplastic urethane resins, polyamide resins, thermoplastic polyimide resins, ketone resins, norbornene resins, styrene-butadiene block copolymers, and polyphenylene ethers. These thermoplastic resins may be modified for the purpose of improving compatibility with an epoxy resin component and the like, and may be used solely, or two or more types thereof may be used in combination.

Further, in the resin composition of the present invention, a thixotropy imparter and a dispersant may be contained according to need. The thixotropy imparter is not particularly limited, and examples thereof polyamide resins, aliphatic polyamide resins, polyamide resins, and dioctyl phthalate resin.

2. Resin Film

The resin film according to the present invention is a resin film that is obtained by drying the resin composition and forming the resin composition into a film shape and in which the content of the solvent is from 0.01 to 5 parts by weight with respect to the entire resin composition.

When flexibility is needed, the content of the solvent is 0.1 parts by weight or more, and more preferably 0.5 parts by weight or more, with respect to the entire resin composition.

The resin film may be a single-layer or multilayer film, but preferably a multilayer film (hereinafter, may be referred to as a multilayer insulating film).

(Manufacturing Method of Multilayer Insulating Film)

A method of manufacturing a multilayer insulating film according to the present invention is not particularly limited, and examples thereof include (i) an extrusion molding method in which materials such as a thermosetting resin, a curing agent, an ultraviolet absorber, a silica, and a solvent are kneaded and then extruded by using an extruder, and formed into a sheet shape by using a T die, a circular die, or the like; (ii) a casting method in which materials such as a thermosetting resin, a curing agent, an ultraviolet absorber, and a silica are dissolved or dispersed in a solvent such as an organic solvent, and then cast to be formed into a sheet shape; and (iii) other conventionally known sheet forming methods.

The thickness of the multilayer insulating film is not particularly limited, but is, for example, from 10 to 300 μm, preferably from 25 to 200 μm, and more preferably from 50 to 180 μm. When the thickness is 10 μm or more, a desired insulating property can be obtained. When the thickness is 300 μm or less, the distance between electrodes of a circuit is not longer than necessary.

3. Multilayer Resin Film

The multilayer resin film of the present invention is a multilayer resin film that is obtained by laminating the resin composition on a base material so as to be in a sheet shape and drying the sheet-shaped resin composition on the base material, and in which the content of the solvent is from 0.01 to 5 parts by weight with respect to the entire resin composition. When the content of the solvent in the multilayer resin film is 0.01 parts by weight or more with respect to the entire resin composition, desired close contact and adhesion are obtained when the multilayer resin film is laminated on a circuit board. When the content of the solvent is 5 parts by weight or less, high evenness is obtained after heat-curing. The multilayer resin film of the present invention is used as an insulating material of a circuit board, and has an excellent processability with an ultraviolet laser.

(Base Material)

Examples of a base material for forming the multilayer resin film of the present invention include polyester films such as polyethylene terephthalate (PET) films and polybutylene terephthalate (PBT) films, polypropylene (PP) films, polyimide films, polyimide amide films, polyphenylene sulfide films, polyetherimide films, fluororesin films, liquid crystal polymer films, and a copper foil. The base material may be further subjected to a mold release treatment according to need. The average thickness of the base material is from 5 to 150 μm, preferably from 5 to 125 μm, and particularly preferably from 25 to 75 μm.

In order to prevent dust from attaching to the base material, a protecting film may be laminated on the base material on the resin side and the base material side. The material of the protecting film may be the same as the material of the base material, or may be different from the material of the base material.

The protecting film is preferably compression-bonded to the base material to such an extent that it can be relatively easily peeled off from the base material. A micro-adhesive layer may be formed and compression-bonded on the protecting film on the base material side. A mold release layer may be formed on the protecting film on the resin side for easy release from the resin. As the mold release layer, a resin layer having mold releasability may be formed, or a mold release agent may be applied.

4. Forming Method of Circuit Board

In the present invention, a circuit board can be formed by: applying the resin composition to a circuit board or laminating the sheet-shaped resin composition on a circuit board; semi-curing or curing the resin composition to obtain a cured film; forming grooves in a surface of the cured film by using an ultraviolet laser; conducting plating on the cured film surface so as to fill the grooves; and removing the plating other than the plating in the grooves. Alternatively, a circuit board can be formed by: curing the resin film of the present invention laminated on the circuit board, to obtain a cured film; forming grooves in a surface of the cured film by using an ultraviolet laser; conducting plating on the cured film surface so as to fill the grooves; removing the plating other than the plating in the grooves. These methods include repeating at least a part of the above processes. Hereinafter, the circuit board obtained thus may be referred to as a multilayer printed wiring board.

Further, plating is conducted so as not to fill the grooves and a circuit is formed according to need, or plating is not conducted, electronic parts such as semiconductor device and condenser are set in the grooves, an electric wiring is formed according to need, and then the grooves and the electronic parts are filled with an insulating resin, thereby obtaining a parts-built-in board. Filling with the insulating resin can be conducted by applying and drying the resin composition of the present invention, or by using a laminating machine or a pressing machine in the form of the resin film of the present invention. Then, a circuit can be formed after grooves are further formed on the filled insulating resin and the above processes are repeated, or after a copper foil is laminated on the filled insulating resin, or after a plating is formed on the filled insulating resin.

(Manufacturing Method of Multilayer Printed Wiring Board)

The following will describe an example of a manufacturing method of a multilayer printed wiring board employing the multilayer insulating film according to the present invention. The manufacturing method of the multilayer printed wiring board according to the present invention includes (i) a first process in which a multilayer film that is formed from a resin composition that includes a base material, a thermosetting resin, a curing agent, an ultraviolet absorber, a silica, and a solvent, is placed on a circuit board, and hot-pressed at a temperature of 10 to 200° C. under a pressure of 0.1 to 30 MPa; and (ii) a second process in which, after the first process, the multilayer insulating film is heated at a temperature of 60 to 200° C.

In the first process, a second layer of the multilayer insulating film is set on a circuit surface formed on the printed board, and hot-pressed at a temperature of 10 to 200° C. under a pressure of 0.1 to 30 MPa with a pressing machine. The first and second processes may be conducted with a single apparatus or separate apparatuses. With the single apparatus, it takes time to change the temperature and hence the productivity tends to decrease, but evenness is excellent. With the separate apparatuses, a time for temperature change is not needed, but many facilities are needed.

Examples of a hot pressing apparatus used for manufacturing the multilayer printed wiring board according to the present invention include a hot pressing machine and a roll laminator. For example, when a pressing machine is used, a known plate-like member such as a metal plate having a smooth surface, a cushioning material, a mold release film, and a protecting film can be inserted between a press mold and the base material of the multilayer film. Similarly, when a roll laminator is used, a cushioning material, a mold release film, a protecting film, and the like can be used.

(Ultraviolet Processing)

Next, in ultraviolet processing, an ultraviolet laser is applied to the cured resin film. Here, the ultraviolet laser generally means a laser that has a wavelength in the range of the wavelength of near-ultraviolet light (wavelength: 380 to 200 nm) within the wavelength of ultraviolet light (wavelength range of 100 to 400 nm).

Examples of the laser having such a wavelength, a KrF excimer laser (wavelength: 248 nm), a YAG-FHG laser (wavelength: 266 nm), and a YAG-THG laser (wavelength: 366 nm).

The application condition of the ultraviolet laser depends on the thickness of a film to be processed and hence cannot be unqualifiedly defined, but, for example, the output power is 0.04 mJ and the number of shots can be varied as appropriate. In the present invention, a carbon dioxide gas laser is not used but an ultraviolet laser is used, and hence the processability is high. Thus, even when a resin composition that contains an inorganic substance is used, grooves can be formed so as to be cleaner in shape and deeper than conventional ones.

Further, processing using another laser such as a carbon dioxide gas laser (wavelength: 1064 nm) may be conducted according to need.

(Pretreatment of Plating)

When a conductor (plating or pattern) is formed on the laminated multilayer printed wiring board by a semi-additive method, a process of swelling the resin surface, a process of roughening the resin surface, a process of attaching a plating catalyst to the roughened resin surface, and further a plating process are conducted. The swelling method is not particularly limited, and a conventionally known technique is used. Examples of the swelling method include a method using: a solution of a compound that contains, as a principal component, dimethylformamide, dimethylsulfoxide, N-methyl-2-pyrrolidone, pyridine, sulfuric acid, sulfonic acid, or the like; or an organic solvent dispersion solution. Among them, for example, a method, in which the multilayer printed wiring board is immersed and shaken in a solution containing ethylene glycol at a temperature of 40 to 85° C. for 1 to 20 minutes, is suitable.

(Roughening Plating)

The surface of a wiring pattern has a surface roughness corresponding to the mirror surface of an electrolytic copper foil, and its surface roughness (Rz) is normally from 0.5 to 2.5 μm and often from 0.5 to 1.5 μm. When a metal plating layer is formed on a wiring pattern having such a very smooth surface, the smoothness of the wiring pattern tends to further increase. Thus, when a metal plating layer is formed directly on the wiring pattern formed as described above, its surface roughness (Rz) often becomes less than 1.1 μm. For that reason, the surface of the multilayer insulating film is preferably subjected to a roughening process.

The method of roughening the surface of the multilayer insulating film is not particularly limited, and a conventionally known technique is used. Examples of the roughening method include a method using: a solution of a chemical oxidant that contains, as a principal component, a manganese compound such as potassium permanganate and sodium permanganate, a chromium compound such as potassium dichromate and potassium chromic anhydride, or a persulphate compound such as sodium persulfate, potassium persulfate, and ammonium persulfate; or an organic solvent dispersion solution. Among them, a method, in which the multilayer printed wiring board is immersed and shaken in a permanganate solution or a sodium hydroxide solution at a temperature of 70 to 85° C., is suitable. The process of attaching a plating catalyst to the roughened resin surface, and the plating process, can be conducted by conventionally known methods.

Next, the multilayer insulating film that has been treated with permanganate and the like is treated with a rinse solution at 25° C., and then washed thoroughly with purified water and dried.

Next, a copper plating process is conducted on the multilayer insulating film whose roughened first surface becomes an outermost surface. Here, a metal plating to be formed is copper plating, but may be tin plating, solder plating, lead-free solder plating, or nickel plating. The multilayer insulating film is treated with an alkaline cleaner to degrease and clean its surface. After the cleaning, the multilayer insulating film is treated with a predip solution, and then treated with an activator solution to attach a palladium catalyst thereto.

Next, the multilayer insulating film is treated with a reducing solution, and immersed in a chemical copper solution to conduct electroless plating until the plating thickness becomes about 0.5 μm. A metal plating layer is formed on the entire surface of the wiring pattern that has been surface-roughened as described above. After the electroless plating, in order to remove residual hydrogen gas, annealing is conducted. Next, electroplating is conducted on the resin sheet that has been electroless-plated. Then, the resin sheet is washed with purified water and dried sufficiently by using a vacuum dryer. Finally, the plating other than the plating in the grooves is polished, to obtain a circuit board having a smooth surface.

The following will describe Examples of the present invention and Comparative Examples, but the present invention is not limited to these Examples.

In manufacturing resin compositions, the following materials are used.

(1) Thermosetting resin 1: biphenyl phenolic epoxy (NC-3000H, available from Nippon Kayaku Co., Ltd.)

(2) Thermosetting resin 2: bisphenol A epoxy (Epicrone 828US, available from Japan Epoxy Resins Co., Ltd.)

(3) Thermosetting resin 3: phenoxy resin (YP-40ASM40, solid content: 40%, available from Tohto Kasei Co., Ltd.)

(4) Curing agent 1: biphenyl phenolic curing agent (MEH-7851H, available from Meiwa Plastic Industries, Ltd.)

(5) Curing agent 2: dicyandiamide (EH3636-AS, available from ADEKA CORPORATION)

(6) Curing agent 3: aminotriazine novolac resin (PHENOLITE ATN LA-1356, available from DIC Corporation)

(7) Curing agent 4: benzophenone tetracarboxylic dianhydride (BTDN, available from Daicel Chemical Industries, Ltd.)

(8) Curing agent 5: terpene-modified phenolic novolac resin (MP402FPY, available from Japan Epoxy Resins Co., Ltd.)

(9) Ultraviolet absorber 1: cyanoacrylate compound 1 (Uvinul 3035, available from BASF AG)

(10) Ultraviolet absorber 2: cyanoacrylate compound 2 (Uvinul 3030, available from BASF AG)

(11) Ultraviolet absorber 3: benzophenone compound (Uvinul 3050, available from BASF AG)

(12) Ultraviolet absorber 4: hydroxyphenyl benzotriazole (Sumisorb-200, available from Sumitomo Chemical Co., Ltd.)

(13) Silica: (Admafine SO—Cl, particle diameter: 0.25 μm, subjected to an epoxy silane coupling treatment, available from Admatechs Company Limited)

(14) Layer silicate: synthetic smectite (Lucentite STN, available from CO—OP Chemical Co., Ltd.)

(15) Solvent: methyl ethyl ketone Curing accelerator:

(16) Curing catalyst: imidazole compound (2MAOK-PW, available from SHIKOKU CHEMICALS CORPORATION)

For the electrical insulating property of a circuit board, a copper pattern was formed with an inter-wiring distance of 20 μm and a wiring width of 20 μm, a voltage of 6V was applied for 100 hours, and an insulation ratio A was measured by using an insulation-resistance meter. Further, a voltage of 6V was applied for 100 hours under the environment of 130° C. and a humidity of 85%, and an insulation ratio B was measured by using the insulation-resistance meter. If the ratio of B to A was maintained to be 75% or more and if migration did not occur between electrodes when a sample was cut after voltage application and the cross section was observed using a microscope, the evaluation was categorized as Excellent. If migration occurred, the evaluation was categorized as Poor.

A sheet-shaped resin composition for forming a multilayer resin film was cut into about 1 cm square pieces, and the weight (a) of 50 pieces was measured. These pieces were dried in a vacuum dryer in substantially a vacuum state for 3 days, and the weight (b) thereof was measured.

The content of the solvent in the sheet-shaped resin composition was calculated by the following formula.

{(a)−(b )}/(a)×100(%)

### Example 1

32.4 parts by weight of the biphenyl phenolic epoxy resin (NC-3000H available from Nippon Kayaku Co., Ltd.), 32.4 parts by weight of the biphenyl phenolic resin (curing agent), 1.62 parts by weight of the dicyandiamide, 0.03 parts by weight of the imidazole compound, the cyanoacrylate compound 1, and 30 parts by weight of the silica as an inorganic filler were blended. The cyanoacrylate compound 1 was blended in an amount of 3.5 parts by weight. The mixture was uniformly kneaded together with 130 parts by weight of methyl ethyl ketone as a solvent by using a homodisper agitator, to prepare a resin composition.

The resin composition was applied on a PET sheet that had a thickness of 50 μm and had been subjected to a mold release treatment, so as to have a thickness of 80 μm after drying, and two sheets that had been dried in an oven at 70° C. for 1 hour were laminated to each other by using a heat laminator at 40° C., to produce a sheet-shaped multilayer film with a thickness of 160 μm.

For the content of the solvent in the resin composition on the mold release PET, a sample was created by cutting the multilayer film into a 10 cm square piece, the weight thereof was measured, and then the sample was placed into a vacuum dryer at 23° C. and dried for 24 hours. The sample was removed from the dryer and the weight of the sample was measured. The difference between the weights before and after the drying was divided by the weight before the drying, to obtain the content of the solvent.

The multilayer film obtained as described above was placed on a circuit board and hot-pressed at a temperature of 100° C. and under a pressure of 0.4 MPa to be laminated thereon. Then, the multilayer insulating film was heated at a temperature of 180° C. for 2 hours to be cured.

Next, grooves were formed with a width of 20 μm and a depth of 10.5 μm by using an ultraviolet laser processing machine (available from Hitachi Via Mechanics, Ltd.) at: a wavelength of 355 nm; a pulse frequency of 30 kHz; an output power of 0.04 mJ; and a shot number of 10. When the processing depth of a later-described Comparative Example 1 was defined as 100%, the processing depth was 128%.

Further, a multilayer film was produced similarly to the above, and then the multilayer insulating film on a circuit board was immersed and shaken in a solution containing ethylene glycol, at a temperature of 75° C. for 20 minutes, to pretreat a resin surface.

Next, in order to roughen the surface of the multilayer insulating film, the multilayer insulating film was put into a roughening solution of potassium permanganate (Concentrate Compact CP, available from Atotech Japan K.K.) at 70° C., and shaken for 5 minutes. In addition, the multilayer insulating film that had been subjected to the permanganate treatment was treated with a rinse solution (Reduction Securigant P, available from Atotech Japan K.K.) at 25° C. for 2 minutes, and then washed thoroughly with purified water and dried.

Next, in order to conduct a copper plating process on the multilayer insulating film whose roughened first surface became an outermost surface, the multilayer insulating film was treated with an alkaline cleaner (Cleaner Securigant 902) at 60° C. for 5 minutes to degrease and clean the surface thereof.

After the cleaning, the multilayer insulating film was treated with a predip solution (Predip Neogant B) at 25° C. for 2 minutes. Then, the multilayer insulating film was treated with an activator solution (Activator Neogant 834) at 40° C. for 5 minutes to attach a palladium catalyst thereto. Next, the multilayer insulating film was treated with a reducing solution (Reducer Neogant WA) at 30° C. for 5 minutes. Next, the multilayer insulating film was put in a chemical copper solution (Basic Printgant MSK-DK, Copper Printgant MSK, and Stabilizer Printgant MSK) to conduct electroless plating until the plating thickness became about 0.5 μm.

After the electroless plating, in order to remove residual hydrogen gas, annealing was conducted at a temperature of 120° C. for 30 minutes. In all the processes to the process of the electroless plating, the treatment solutions each having a volume of 1 L were used in a beaker scale, and each process was conducted with the multilayer insulating film being shaken.

Next, a photosensitive dry film (PHOTEC RY-3315, available from Hitachi Chemical Company, Ltd.) was hot-pressed on the electroless plating at a temperature of 80 to 100° C. under a pressure of 0.3 to 0.4 MPa to be bonded thereto, and processes of exposure and development were conducted, thereby forming a plating resist pattern.

Next, electroplating was conducted on the above sample until the plating thickness became 10 μm, to form a wiring pattern with a pattern width of 20 μm and an inter-pattern distance of 20 μm. A copper sulfate plating solution was used for electric copper plating, and an electric current was 0.6 A/cm². Next, a plating resist was peeled off, and the electroless plating between patterns was removed by quick etching (SAC, available from Ebara Densan Ltd.) to form a wiring. Then, after-bake was conducted at 180° C. for 1 hour. Then, the sample was thoroughly washed with purified water, and thoroughly dryed by using a vacuum dryer to produce a circuit board.

Finally, the resin composition was hot-pressed on the circuit board at a temperature of 100° C. under a pressure of 0.4 MPa to be laminated thereon, and then the multilayer insulating film was heated at a temperature of 180° C. for 2 hours to be cured, thereby producing a circuit board for evaluating an electrical insulating property. The electrical insulating property of this circuit board was excellent. The result is shown in the following Table 1. In Table 1, the unit of the contents of the thermosetting resin, the curing agent, the silica, and the ultraviolet absorber is parts by weight.

### Comparative Example 1

A resin composition was prepared in a similar manner as Example 1, except that no ultraviolet absorber was blended. A multilayer film was prepared in a similar manner as Example 1 and laminated on a circuit board, and then a cured body of the multilayer insulating film was obtained.

Next, grooves were formed by using the ultraviolet laser processing machine in a similar manner as Example 1. The processing depth was 28% shallower than that of Example (this depth was defined as 100% for evaluating other Examples and Comparative Examples).

Then, treatment was conducted in a similar manner as Example 1, to obtain a circuit board having a smooth surface. The electrical insulating property of this circuit board was evaluated, and the result is shown in the following Table 1.

### Example 2

A resin composition was prepared in a similar manner as Example 1, except that the cyanoacrylate compound 2 was used as an ultraviolet absorber as shown in the following Table 1. A multilayer film was prepared in a similar manner as Example 1, and a cured body of the multilayer insulating film was obtained.

Next, grooves were formed by using the ultraviolet laser processing machine. Then, treatment was conducted in a similar manner as Example 1, to obtain a circuit board having a smooth surface. The electrical insulating property of this circuit board was evaluated, and the result is shown in the following Table 1.

### Example 3

A resin composition was prepared in a similar manner as Example 1, except that the benzophenone compound was used as an ultraviolet absorber as shown in the following Table 1. A multilayer film was prepared in a similar manner as Example 1, and a cured body of the multilayer insulating film was obtained.

Next, grooves were formed by using the ultraviolet laser processing machine in a similar manner as Example 1. Then, treatment was conducted in a similar manner as Example 1, to obtain a circuit board having a smooth surface. The electrical insulating property of this circuit board was evaluated, and the result is shown in the following Table 1.

### Examples 4 to 6 and Example 12

Resin compositions were prepared in a similar manner as Example 1, except that the blending amount of the ultraviolet absorber was changed as shown in the following Table 1. Multilayer films were prepared in a similar manner as Example 1, and cured bodies of the multilayer insulating films were obtained.

Next, grooves were formed by using the ultraviolet laser processing machine in a similar manner as Example 1. The processing depths of the grooves were as shown in Table 1. Then, treatment was conducted in a similar manner as Example 1, to obtain circuit boards each having a smooth surface. The electrical insulating properties of these circuit boards were evaluated, and the results are shown in the following Table 1.

### Comparative Example 3

A resin composition was prepared in a similar manner as Example 4, except that the hydroxyphenyl benzotriazole was used as an ultraviolet absorber. A multilayer film was prepared in a similar manner as Example 1, and a cured body of the multilayer insulating film was obtained.

Next, grooves were formed by using the ultraviolet laser processing machine in a similar manner as Example 1. Then, treatment was conducted in a similar manner as Example 1, to obtain a circuit board having a smooth surface. The electrical insulating property of this circuit board was evaluated, and the result is shown in the following Table 1.

### Example 7

A resin composition was prepared in a similar manner as Example 1, except that the aminotriazine novolac resin was used instead of the biphenyl phenolic resin and the blending amount of each ingredient was as follows.

The blending amount of the biphenyl phenolic epoxy resin was 41.5 parts by weight; the blending amount of the aminotriazine novolac resin was 21.9 parts by weight; the blending amount of the dicyandiamide was 3.15 parts by weight; the blending amount of the imidazole compound was 0.03 parts by weight; the blending amount of the silica was parts by weight; and the blending amount of the cyanoacrylate compound 1 was 3.5 parts by weight.

A multilayer film was prepared by using this resin composition in a similar manner as Example 1, and a cured body of the multilayer insulating film was obtained.

Next, grooves were formed by using the ultraviolet laser processing machine in a similar manner as Example 1. Then, treatment was conducted in a similar manner as Example 1, to obtain a circuit board having a smooth surface. The electrical insulating property of this circuit board was evaluated, and the result is shown in the following Table 2. In Table 2, the unit of the contents of the thermosetting resin, the curing agent, the silica, and the ultraviolet absorber is parts by weight.

### Comparative Example 4

A resin composition was prepared in a similar manner as Example 7, except that no ultraviolet absorber was blended. A multilayer film was prepared in a similar manner as Example 7, and a cured body of the multilayer insulating film was obtained.

Next, grooves were formed by using the ultraviolet laser processing machine in a similar manner as Example 1. Then, treatment was conducted in a similar manner as Example 1, to obtain a circuit board having a smooth surface. The electrical insulating property of this circuit board was evaluated, and the result is shown in the following Table 2.

### Examples 8 and 9

A resin composition was prepared in a similar manner as Example 1, except that the benzophenone tetracarboxylic dianhydride or the terpene-modified phenolic novolac resin was used instead of the biphenyl phenolic resin and the blending amount of each ingredient was as follows.

In Example 8, the blending amount of the biphenyl phenolic epoxy resin was 43.0 parts by weight; the blending amount of the benzophenone tetracarboxylic dianhydride was 20.1 parts by weight; the blending amount of the dicyandiamide was 3.28 parts by weight; the blending amount of the imidazole compound was 0.03 parts by weight; the blending amount of the silica was 30 parts by weight; and the blending amount of the cyanoacrylate compound 1 was 3.5 parts by weight. In Example 9, the blending amount of the biphenyl phenolic epoxy resin was 43.0 parts by weight; the blending amount of the terpene-modified phenolic novolac resin was 25.3 parts by weight; the blending amount of the dicyandiamide was 3.28 parts by weight; the blending amount of the imidazole compound was 0.03 parts by weight; the blending amount of the silica was 30 parts by weight; and the blending amount of the cyanoacrylate compound 1 was 3.5 parts by weight.

Multilayer films were prepared by using these resin compositions in a similar manner as Example 1, and cured bodies of the multilayer insulating films were obtained.

Next, grooves were formed by using the ultraviolet laser processing machine at an output power of 0.04 mJ and a shot number of 10. The processing depths of the grooves were as shown in Table 2.

Then, treatment was conducted in a similar manner as Example 1, to obtain circuit boards each having a smooth surface. The electrical insulating properties of these circuit boards were evaluated, and the results are shown in the following Table 2.

### Reference Example 1 and Comparative Example 6

Resin compositions were prepared in a similar manner as Examples 8 and 9, except that no ultraviolet absorber was blended. Multilayer films were prepared in a similar manner as Example 1, and cured bodies of the multilayer insulating films were obtained.

Next, grooves were formed by using the ultraviolet laser processing machine in a similar manner as Example 1. The processing depths of the grooves were as shown in Table 2.

Then, treatment was conducted in a similar manner as Example 1, to obtain circuit boards each having a smooth surface. The electrical insulating properties of these circuit boards were evaluated, and the results are shown in the following Table 2.

### Example 10

A resin composition was prepared in a similar manner as Example 1, except that the bisphenol A epoxy resin was used instead of the biphenyl phenolic epoxy resin (NC-3000H) and the blending amount of each ingredient was as follows.

27.5 parts by weight of the bisphenol A epoxy resin, 37.3 parts by weight of the biphenyl phenolic curing agent, 1.62 parts by weight of the dicyandiamide, 0.03 parts by weight of the imidazole compound, the cyanoacrylate compound 1, and 30 parts by weight of the silica as an inorganic filler were blended. The cyanoacrylate compound 1 was blended in an amount of 3.5 parts by weight with respect to the biphenyl phenolic epoxy resin and the biphenyl phenolic resin (curing agent). Then, the mixture was uniformly kneaded together with 130 parts by weight of methyl ethyl ketone as a solvent by using a homodisper agitator, to prepare a resin composition.

A multilayer film was prepared by using this resin composition in a similar manner as Example 1, and a cured body of the multilayer insulating film was obtained.

Next, grooves were formed by using the ultraviolet laser processing machine in a similar manner as Example 1. Then, treatment was conducted in a similar manner as Example 1, to obtain a circuit board having a smooth surface. When the electrical insulating property of this circuit board was evaluated, the result was excellent. The result is shown in the following Table 1.

### Example 11

A resin composition was prepared in a similar manner as Example 1, except that the layer silicate (synthesize smectite) was added and the blending amount of each ingredient was as follows.

32.1 parts by weight of the biphenyl phenolic epoxy resin (NC-3000H), 32.1 parts by weight of the biphenyl phenolic curing agent, 1.60 parts by weight of the dicyandiamide, 0.03 parts by weight of the imidazole compound, the cyanoacrylate compound 1, and 29.6 parts by weight of the silica as an inorganic filler were blended. The cyanoacrylate compound 1 was blended in an amount of 3.5 parts by weight with respect to the biphenyl phenolic epoxy resin and the biphenyl phenolic resin (curing agent). Then, the mixture was uniformly kneaded together with 130 parts by weight of methyl ethyl ketone as a solvent by using a homodisper agitator, to prepare a resin composition.

A multilayer film was prepared by using this resin composition in a similar manner as Example 1, and a cured body of the multilayer insulating film was obtained.

Next, grooves were formed by using the ultraviolet laser processing machine in a similar manner as Example 1. Then, treatment was conducted in a similar manner as Example 1, to obtain a circuit board having a smooth surface. When the electrical insulating property of this circuit board was evaluated, the result was excellent. The result is shown in the following Table 1.

### Examples 13 to 15

Resin compositions were prepared in a similar manner as Example 1, except that mixtures of the thermosetting resin 1 and the thermosetting resin 2 were used as a thermosetting resin and the blending amount of the solvent was changed as shown in Table 1. Multilayer films were prepared in a similar manner as Example 1 and laminated on circuit boards, and then cured bodies of the multilayer insulating films were obtained.

Next, grooves were formed by using the ultraviolet laser processing machine in a similar manner as Example 1. The processing depths were evaluated, and the results are shown in Table 1.

Then, treatment was conducted in a similar manner as Example 1, to obtain circuit boards each having a smooth surface. The electrical insulating properties of these circuit boards were evaluated, and the results are shown in the following Table 1.

### Example 16

A resin composition was prepared in a similar manner as Example 1, except that a mixture of the thermosetting resin 1 and the thermosetting resin 3 was used as a thermosetting resin as shown in Table 1. A multilayer film was prepared in a similar manner as Example 1 and laminated on a circuit board, and then a cured body of the multilayer insulating film was obtained.

Next, grooves were formed by using the ultraviolet laser processing machine in a similar manner as Example 1. The processing depth was evaluated, and the result is shown in Table 1.

Then, treatment was conducted in a similar manner as Example 1, to obtain a circuit board having a smooth surface. The electrical insulating property of this circuit board was evaluated, and the result is shown in the following Table 1.

### Comparative Example 7

A resin composition was prepared in a similar manner as Example 8, except that the hydroxyphenyl benzotriazole was blended as an ultraviolet absorber.

A multilayer film was prepared in a similar manner as Example 1, and a cured body of the multilayer insulating film was obtained.

Next, grooves were formed by using the ultraviolet laser processing machine in a similar manner as Example 1. The processing depth of the grooves was as shown in Table 2.

Then, treatment was conducted in a similar manner as Example 1, to obtain a circuit board having a smooth surface. The electrical insulating property of this circuit board was evaluated, and the result is shown in the following Table 2.

TABLE 1

| | Thermosetting resin | | | Curing Agent | | | | |
|---|---|---|---|---|---|---|---|---|
| | Thermosetting | Thermosetting | Thermosetting | Curing | Curing | Curing | Curing | Curing |
| | resin 1 | resin 2 | resin 3 | agent 1 | agent 2 | agent 3 | agent 4 | agent 5 |
| Example 1 | 32.40 | | | 32.40 | 1.62 | | | |
| Example 2 | 32.40 | | | 32.40 | 1.62 | | | |
| Example 3 | 32.40 | | | 32.40 | 1.62 | | | |
| Example 12 | 32.40 | | | 32.40 | 1.62 | | | |
| Example 4 | 32.40 | | | 32.40 | 1.62 | | | |
| Example 5 | 32.40 | | | 32.40 | 1.62 | | | |
| Example 6 | 32.40 | | | 32.40 | 1.62 | | | |
| Example 10 | | 27.50 | | 37.30 | 1.62 | | | |
| Example 11 | 32.40 | | | 32.40 | 1.62 | | | |
| Example 13 | 27.54 | 4.86 | | 32.40 | 1.62 | | | |
| Example 14 | 22.68 | 9.72 | | 32.40 | 1.62 | | | |
| Example 15 | 16.20 | 16.20 | | 32.40 | 1.62 | | | |
| Example 16 | 22.68 | | 9.72 | 32.40 | 1.62 | | | |
| Comparative | 32.40 | | | 32.40 | 1.62 | | | |
| Example 1 | | | | | | | | |
| Comparative | 32.40 | | | 32.40 | 1.62 | | | |
| Example 3 | | | | | | | | |

Ultraviolet absorber

| | Ultraviolet | Ultraviolet | Ultraviolet | Ultraviolet | | Layer | |
|---|---|---|---|---|---|---|---|
| | absorber 1 | absorber 2 | absorber 3 | absorber 4 | Silica | silicate | Solvent |
| Example 1 | 3.50 | | | | 30.00 | | 130 |
| Example 2 | | 3.50 | | | 30.00 | | 130 |
| Example 3 | | | 3.50 | | 30.00 | | 130 |
| Example 12 | 0.50 | | | | 30.00 | | 130 |
| Example 4 | 5.00 | | | | 30.00 | | 130 |
| Example 5 | 10.00 | | | | 30.00 | | 130 |
| Example 6 | 20.00 | | | | 30.00 | | 130 |
| Example 10 | 3.50 | | | | 30.00 | | 130 |
| Example 11 | 3.50 | | | | 30.00 | 1.00 | 130 |
| Example 13 | 3.50 | | | | 30.00 | | 120 |
| Example 14 | 3.50 | | | | 30.00 | | 80 |
| Example 15 | 3.50 | | | | 30.00 | | 50 |
| Example 16 | 3.50 | | | | 30.00 | | 130 |
| Comparative | — | — | — | — | 30.00 | | 130 |
| Example 1 | | | | | | | |
| Comparative | | | | 5.00 | 30.00 | | 130 |
| Example 3 | | | | | | | |

| | | | Processing | | |
|---|---|---|---|---|---|
| | | | depth | | |
| | | Residual | (Comparative | Processing | |
| | | solvent | Example 1 is | depth | Electrical |
| | Curing | amount | defined as | improvement | insulating |
| | accelerator | (wt %) | 100%) | rate % | property |
| Example 1 | 0.03 | 3.1 | 128 | 128 | Excellent |
| Example 2 | 0.03 | 3.1 | 127 | 127 | Excellent |
| Example 3 | 0.03 | 3.1 | 127 | 127 | Excellent |
| Example 12 | 0.03 | 3.1 | 102 | 102 | Excellent |
| Example 4 | 0.03 | 3 | 130 | 130 | Excellent |
| Example 5 | 0.03 | 2.8 | 132 | 132 | Excellent |
| Example 6 | 0.03 | 2.4 | 135 | 135 | Excellent |
| Example 10 | 0.03 | 3.1 | 125 | 125 | Excellent |
| Example 11 | 0.03 | 3.1 | 128 | 125 | Excellent |
| Example 13 | 0.03 | 3 | 129 | 129 | Excellent |
| Example 14 | 0.03 | 2.8 | 138 | 138 | Excellent |
| Example 15 | 0.03 | 2.7 | 142 | 142 | Excellent |
| Example 16 | 0.03 | 3.3 | 127 | 127 | Excellent |
| Comparative | 0.03 | 3.1 | 100 | — | Excellent |
| Example 1 | | | | | |
| Comparative | 0.03 | 3 | 98 | | Poor |
| Example 3 | | | | | |

TABLE 2

| | Thermosetting resin | | | Curing Agent | | | | |
|---|---|---|---|---|---|---|---|---|
| | Thermosetting | Thermosetting | Thermosetting | Curing | Curing | Curing | Curing | Curing |
| | resin 1 | resin 2 | resin 3 | agent 1 | agent 2 | agent 3 | agent 4 | agent 5 |
| Example 7 | 41.50 | | | | 3.15 | 21.90 | | |
| Comparative | 41.50 | | | | 3.15 | 21.90 | | |
| Example 4 | | | | | | | | |
| Example 8 | 43.00 | | | | 3.28 | | 20.10 | |
| Reference | 43.00 | | | | 3.28 | | 20.10 | |
| Example 1 | | | | | | | | |
| Example 9 | 43.00 | | | | 3.28 | | | 25.30 |
| Comparative | 43.00 | | | | 3.28 | | | 25.30 |
| Example 6 | | | | | | | | |
| Comparative | 43.00 | | | | 3.28 | | 20.10 | |
| Example 7 | | | | | | | | |

Ultraviolet absorber

| | Ultraviolet | Ultraviolet | Ultraviolet | Ultraviolet | | Layer | |
|---|---|---|---|---|---|---|---|
| | absorber 1 | absorber 2 | absorber 3 | absorber 4 | Silica | silicate | Solvent |
| Example 7 | 3.50 | | | | 30.00 | | 130 |
| Comparative | — | — | — | — | 30.00 | | 130 |
| Example 4 | | | | | | | |
| Example 8 | 3.50 | | | | 30.05 | | 130 |
| Reference | — | — | — | — | 30.00 | | 130 |
| Example 1 | | | | | | | |
| Example 9 | 3.50 | | | | 30.00 | | 130 |
| Comparative | — | — | — | — | 30.00 | | 130 |
| Example 6 | | | | | | | |
| Comparative | | | | 3.50 | 30.00 | | 130 |
| Example 7 | | | | | | | |

| | | | Processing | | |
|---|---|---|---|---|---|
| | | | depth | | |
| | | Residual | (Comparative | | |
| | | solvent | Example 1 is | | Electrical |
| | Curing | amount | defined as | Processing depth | insulating |
| | accelerator | (wt %) | 100%) | improvement rate % | property |
| Example 7 | 0.03 | 2.8 | 108 | 108 (as compared to | Excellent |
| | | | | Comparative Example | |
| | | | | 4) | |
| Comparative | 0.03 | 2.8 | 100 | — | Excellent |
| Example 4 | | | | | |
| Example 8 | 0.03 | 2.6 | 138 | 106 (as compared to | Excellent |
| | | | | Reference Example 1) | |
| Reference | 0.03 | 2.6 | 130 | — | Excellent |
| Example 1 | | | | | |
| Example 9 | 0.03 | 2.4 | 77 | 110 (as compared to | Excellent |
| | | | | Comparative Example | |
| | | | | 6) | |
| Comparative | 0.03 | 2.4 | 70 | — | Excellent |
| Example 6 | | | | | |
| Comparative | 0.03 | 2.6 | 130 | — | Poor |
| Example 7 | | | | | |

[Evaluation]

As is clear from the results shown in the above Tables 1 and 2, in Examples 1 to 16, because thermosetting resin compositions each of which contained: a specific curing agent; the silica; 0.5 to 20 parts by weight of the cyanoacrylate compound or the benzophenone compound as an ultraviolet absorber; and a specific amount of the solvent, were used, the processing depth provided by an ultraviolet laser is great, and the processability is high. In addition, the electrical insulating properties of the obtained circuit boards are also excellent.

In contrast, in Comparative Examples 1, 4, and 6, because no ultraviolet absorber was used, it appears that the processing depth provided by ultraviolet laser processing is shallow and the processability is low. In Comparative Examples 3 and 7, as a result of using, as an ultraviolet absorber, the hydroxyphenyl benzotriazole that is described in Patent Document 2, the processability with an ultraviolet laser is poor, and the electrical insulating properties of the obtained circuit boards are poor.

### INDUSTRIAL APPLICABILITY

The resin composition of the present invention has a great processing depth and a high processability with an ultraviolet laser, and hence a resin film employing the resin composition is suitable as an electrical insulating material of a circuit board.

1. A resin composition comprising a thermosetting resin (A), a curing agent (B), a silica (C), an ultraviolet absorber (D), and a solvent (E), wherein
the ultraviolet absorber (D) is one or more compounds selected from a cyanoacrylate compound (D1) and a benzophenone compound (D2),
the content of the ultraviolet absorber (D) is from 0.5 to 50 parts by weight per 100 parts by weight of the total amount of the thermosetting resin (A), the curing agent (B), and the ultraviolet absorber (D), and
the blending amount of the solvent (E) is from 20 to 500 parts by weight per 100 parts by weight of the total amount of the thermosetting resin (A) and the curing agent (B).

2. The resin composition according to claim 1, wherein the content of the ultraviolet absorber (D) is from 1.0 to 30 parts by weight per the total amount of the thermosetting resin (A), the curing agent (B), and the ultraviolet absorber (D).

3. The resin composition according to claim 1, wherein the cyanoacrylate compound (D1) or the benzophenone compound (D2) has an absorption maximum in a wavelength range of 200 to 380 nm.

4. The resin composition according to claim 1, wherein the cyanoacrylate compound (D1) is a compound that has one or more types of groups selected from an alkyl group with 1 to 10 carbons, a cycloalkyl group, an aryl group, an aryl-alkyl group, and two or more aryl-acryloxy groups.

5. The resin composition according to claim 4, wherein the cyanoacrylate compound (D1) is a compound that has an alkyl group with 2 to 8 carbons and two aryl groups, or a compound that has two or more aryl-acryloxy groups.

6. The resin composition according to claim 1, wherein the benzophenone compound (D2) is benzophenone; a compound that has one of a hydroxyl group, a hydroxy-alkyl group, an alkyloxy group, an aryloxy group, an aryl-alkyloxy group, and a carboxyl group; or an acid anhydride of the compound.

7. The resin composition according to claim 6, wherein the benzophenone compound (D2) is a compound that has one of a hydroxyl group and a hydroxy-alkyl group, or an acid anhydride of the compound.

8. The resin composition according to claim 1, wherein the weight ratio of the thermosetting resin (A) to the curing agent (B) is from 30:70 to 70:30.

9. The resin composition according to claim 1, wherein the thermosetting resin (A) includes at least an epoxy resin.

10. The resin composition according to claim 1, wherein the curing agent (B) includes one or more compounds selected from dicyandiamide, a phenolic curing agent, and an acid anhydride.

11. The resin composition according to claim 1, wherein the blending amount of the silica (C) is from 10 to 100 parts by weight per 100 parts by weight of the total amount of the thermosetting resin (A) and the curing agent (B).

12. The resin composition according to claim 11, wherein the silica (C) is surface-treated with a silane coupling agent.

13. The resin composition according to claim 1, further comprising a layer silicate, wherein
the content of the layer silicate is from 0.1 to 25 parts by weight per 100 parts by weight of the total amount of the thermosetting resin (A) and the curing agent (B).

14. A multilayer resin film in which a resin composition according to claim 1 and a base material are laminated to each other, wherein
the resin composition is formed in a sheet shape,
the sheet-shaped resin composition is dried, and
the content of the solvent in the sheet-shaped resin composition is from 0.01 to 5% parts by weight.

15. The multilayer resin film according to claim 14, wherein the multilayer resin film is used as an insulating material of a circuit board and has an excellent processability for ultraviolet laser processing.
